(19) United States
(12) Patent Application Publication
(10) Pub. No.: US 2015/0199030 A1
(43) Pub. Date: Jul. 16, 2015

(54) Hover-Sensitive Control Of Secondary Display

(71) Applicant: Microsoft Corporation, Redmond, WA (US)

(72) Inventors: Petteri Mikkola, Bellevue, WA (US); Dan Hwang, Renton, WA (US)

(73) Assignee: Microsoft Corporation, Redmond, WA (US)

(21) Appl. No.: 14/152,082

(22) Filed: Jan. 10, 2014

(51) Int. Cl. G06F 3/033; G06F 3/048

(52) U.S. Cl. CPC G06F 3/033; G06F 3/048

(57) ABSTRACT

Example apparatus and methods concern a first device (e.g., phone, tablet) having a touch and hover-sensitive display. The first device may detect a second device (e.g., television, monitor) that has a second display. After establishing a communication link and a context between the first and second device, the first device may provide a first output (e.g., movie, game) to be displayed on the second device. In response to identifying a hover point produced in a hover space associated with the first device, the first device may provide a second output (e.g., user interface element, cursor) for display on the second display. The second output may be based on the context and on a hover action associated with the hover point. The user may then cause a control event to be generated by interacting with the second display using the second output in relation to the cursor.

### BACKGROUND

Users are familiar with remote controls for their television, their DVD (digital versatile disk) player, their game console, and other devices. These remote controls tend to have fixed physical buttons mapped to pre-defined control actions. For example, the on/off button on a television remote control may always be in the same location and perform the same function. Similarly, the “right trigger” and “left trigger” buttons on a game controller may always be in the same location and may always be mapped to the same control action for an application (e.g., game). Conventional device controllers (e.g., game controllers, keyboards, game controls) have had physical buttons that provided a user with physical touch points that helped a user make a desired input without having to look down at the controller. These conventional controllers have not had their own displays and have only been useful for their intended dedicated purpose.

The prevalence of touch sensitive devices (e.g., smart phones, tablets) has added yet another piece of electronics equipment to the users already-crowded daily life. Attempts have been made to replace conventional, dedicated, button-centric controllers with touch sensitive devices. However, smart phones, tablets, and other touch sensitive devices do not have the familiar buttons at the familiar locations and therefore have not yielded acceptable results. Conventional attempts to use touch sensitive devices having their own displays (e.g., phone, tablet) have followed a model where a control is displayed on the touch sensitive device. For example, for a DVD player control, the phone may display DVD controls on the phone. This results in a “heads-down” operation where the users focus is directed towards the hand held touch sensitive device rather than a secondary display. Even when corresponding controls are displayed on both a secondary display and a touch sensitive device, the corresponding controls tend to be tightly coupled between the handheld device and the secondary display and thus the user tends to switch their focus to the hand held touch sensitive device to make sure they are pressing the desired button.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed towards producing a heads-up interaction where a user keeps their attention on a secondary display (e.g., television) while using a hover-sensitive device (e.g., phone, tablet) as a controller for an application whose output is being displayed on the secondary display. Breaking away from the conventional corresponding controls model facilitates producing the heads-up interaction. Unlike conventional systems that display a control on the phone, example methods and apparatus may not display the control on the phone. Instead, a control may be displayed on a secondary display and hover interactions with the phone may be used to move a cursor on the secondary display. When the cursor is positioned as desired by the user on the secondary display (e.g., over a control), then a touch interaction on the phone may activate the control. Since there is nothing to look at on the phone, the user's attention remains on the secondary display. Example apparatus and methods use hover and touch interactions on a touch and hover-sensitive device to provide visual feedback on a secondary display and as a proxy for physical buttons.

Some embodiments may include a capacitive input/output (i/o) interface that is sensitive to both touch and hover actions. The capacitive i/o interface may detect objects (e.g., finger, thumb, stylus) that touch the screen. The capacitive i/o interface may also detect objects (e.g., finger, thumb, stylus) that are not touching the screen but that are located in a three dimensional volume (e.g., hover space) associated with the screen. The capacitive i/o interface may be able to simultaneously detect a touch action and a hover action. The capacitive i/o interface may be able to detect multiple simultaneous touch actions and multiple simultaneous hover actions. A first device (e.g., phone) may establish a context with which the first device will interact with a secondary device (e.g., television, computer monitor, game monitor). The first device may provide a hover interface that facilitates moving a cursor on the secondary device. The first device may also provide output from an application running on the first device. For example, a phone may screencast a game to a game monitor and allow a user to move a cursor around on the game monitor using hover actions on the phone.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example touch and hover-sensitive device.

FIG. 2 illustrates an example touch and hover-sensitive device interacting with a secondary display.

FIG. 3 illustrates a portion of an example touch and hover-sensitive device configured to perform hover-sensitive control of a secondary display.

FIG. 4 illustrates a portion of an example touch and hover-sensitive device configured to perform hover-sensitive control of a secondary display.

FIG. 5 illustrates an example method associated with performing hover-sensitive control of a secondary display.

FIG. 6 illustrates an example method associated with performing hover sensitive control of a secondary display.

FIG. 7 illustrates an example cloud operating environment in which a touch and hover-sensitive interface may provide hover-sensitive control of a secondary display.

FIG. 8 is a system diagram depicting an exemplary mobile communication device configured with a touch and hover-sensitive interface configured to perform hover-sensitive control of a secondary display.

FIG. 9 illustrates an example apparatus that provides hover-sensitive control of a secondary display.

FIG. 10 illustrates an example hover-sensitive device interacting with a secondary display.

### DETAILED DESCRIPTION

As devices like phones and tablets become even more ubiquitous, users' expectations about the functions that ought to be performed by their “phone” have risen dramatically. Thus, these devices have begun to light up experiences on external displays (e.g., televisions, game monitors). However, devices as controllers have typically produced a heads-down experience where it has been difficult, if even possible at all, to control or provide input to what is displayed on the secondary display. The heads-down experience results from having to look down at the phone or tablet to make sure that the user is touching the “right” location. Example apparatus and methods detect touch actions performed by objects that touch an i/o interface on a first device (e.g., phone, tablet). Example apparatus and methods also detect hover actions performed by objects in a hover space associated with the i/o interface. Example apparatus and methods use touch actions and hover actions performed at the i/o interface on the first device to control displays and interactions with a secondary display in a “heads-up” experience,

Example apparatus and methods may allow user interface elements that operate as controls to be displayed on the secondary display. Unlike conventional systems that tightly couple user interface elements on the touch device (e.g., phone, tablet) with the user interface elements on the secondary display, example apparatus and methods may decouple or at least less tightly couple the user interface elements to produce the heads-up experience. A hover point may be established with respect to a digit (e.g., thumb) in a hover space associated with a hover-sensitive device (e.g., phone, tablet). The hover point may be used to control the presence, location, appearance, and function of a cursor displayed on the secondary display. For example, as the user moves their thumb in x, y, or z directions in the hover space, the cursor may move around on the secondary display. In one embodiment, the surface of the hover-sensitive device may be mapped to the surface of the secondary display. But in another embodiment, the surface of the hover-sensitive device may not be mapped to the surface of the secondary display and the hover movements may position the cursor independent of where in the hover space the hover point is located. The hover movements may cause inputs similar to those that would be provided by a track ball. While the term “cursor” is used to refer to the item being presented on the secondary display, more generally, a hover point or other visual indicia may be presented on the secondary display to indicate the point being controlled on the secondary display by the hover point in the hover space on the hover-sensitive device.

Example apparatus and methods may also provide “shy” (e.g. as-needed) controls for the secondary display. For example, when a user is watching a movie, there may be no need to display the controls for a DVD-like interface on the secondary display. But a user may want to be able to pause the movie. Example apparatus and methods may detect that the secondary display is playing a movie and configure the hover-sensitive device to provide a DVD-like interface to the secondary display on an as-needed basis. For example, the hover-sensitive device may be configured to cause the DVD-like interface to be displayed when the hover-sensitive device detects a hover action. The hover point may be used to control the presence, location appearance, and function of a virtual control element on the secondary display. For example, when the user brings a thumb into the hover space, the DVD-like interface may be super-imposed over the movie and a cursor displayed on the secondary display. The user may then make hover motions that reposition the cursor, and, may ultimately make a touch action that causes the button under the cursor to be “pressed.” In one embodiment, the DVD-like interface may be partially transparent.

By not directly mapping locations on the hover-sensitive device to the secondary display, example apparatus and methods may allow the hover-sensitive device to act more like a controller and less like a miniature version of the secondary display. In one embodiment, the cursor may initially be positioned in the center of the secondary display regardless of where the hover point is established. Since the user knows that the cursor will appear in the middle of the secondary display no matter where they establish the hover point on the hover-sensitive device, there is no incentive for the user to look at the hover-sensitive device. In another embodiment, the cursor may be positioned over a most-likely to be used control on the secondary display regardless of where the hover point is established on the hover-sensitive device. Again, because the user knows that the cursor will appear in a pre-defined position that is independent of where the hover point is established on the hover-sensitive device, there is no incentive to look down at the hover-sensitive device, which promotes the heads-up experience. In one embodiment, the cursor may initially be placed based on the location of the hover point. Since the control is displayed on the secondary device, there is no need or even use for the user to look at the hover-sensitive device. As the user moves their thumb around in the hover space the cursor may move. Ultimately, the user may decide to “press” a button on the secondary display by touching the hover and touch-sensitive device. It may not matter where on the hover and touch-sensitive device the user touches, it may only matter that the user touched the hover and touch-sensitive device while it was providing the cursor and the DVD-like interface to the secondary display.

Consider a scenario where a user is using a phone with the ability to “screencast” a screen from their phone to a secondary screen. For example, the phone may be able to Miracast to the secondary screen. The secondary screen may have been launched by their phone or by another device or process. Example apparatus and methods provide the phone with the ability to provide a hover-on-secondary display functionality. The hover-on-secondary display functionality may allow a user to run a game on their phone, display the game on the secondary display, and use the phone as a hover controller for the game. The hover control provided by the phone may allow a game control or system level control to be displayed on the game on the secondary display. The hover control provided by the phone may also allow a representation of the user's digits (e.g., thumbs) to be displayed on the secondary display.

In one embodiment, the phone may recognize that there is a second display available and may therefore enable “hover touch points” on the second display. For example, when playing a game, the user may see the same image on their phone and on the secondary display, but the second display may highlight a hover point(s) produced by the phone. The secondary display (e.g., television, game monitor) may show icons (e.g., translucent circles) that represent the locations of the user's digits. The size, shape, color, or other attribute of the icon may change based on the z-distance between the users digits and the phone. For example, when a digit is closer to the phone the icon may be small and bright while when the digit is farther from the phone the icon may be large and dim. When the user touches the screen, the icon may change color or shape.

While games and movies are two use cases, hover touch points associated with hover-on-secondary functionality may also be used in productivity scenarios. For example, a user may be displaying a document for collaborative editing. The user may be presented with a virtual keyboard or an editing menu when they hover a digit over the hover-sensitive device. No corresponding keyboard or menu may be displayed on the hover-sensitive device and thus there is no incentive to look down at the hover-sensitive device.

In another example, a user may be presenting a slide show and using their phone as a controller. The phone may provide a “laser pointer” functionality that allows the user to point out or highlight items on the slide show and may also provide a next/previous function that allows the user to move to the next slide or to the previous slide. Since the hover interactions may not depend on the location of any control on the phone, there would be no reason for the user to look at the phone, which facilitates keeping focus on the slide show.

While a single user with a single phone has been described so far, example apparatus and methods may provide hover touch points on a secondary display for multiple users or multiple phones that are sharing a single secondary display or even multiple secondary displays. For example, two users who are playing a football game may each be provided a cursor that can be used to control a player displayed on the secondary display. Or, multiple users who are collaborating in a team-oriented video game may each have a cursor displayed on a community secondary display to facilitate interacting with virtual controls and with each other.

Touch technology is used to detect an object that touches a touch-sensitive screen. “Touch technology” and “touch sensitive” refer to sensing an object that touches the i/o interface. The i/o interface may be, for example, a capacitive interface. The capacitance sensed by a capacitive sensor may be affected by the different dielectric properties and effects on capacitance of an object that touches a screen. For example, the dielectric properties of a finger are different than the dielectric properties of air. Similarly, the dielectric properties of a stylus are different than the dielectric properties of air. Thus, when either the finger or stylus touches the capacitive i/o interface, the change in capacitance can be sensed and used to identify an input action. While a capacitive i/o interface is described, more generally a touch sensitive i/o interface may be employed.

Hover technology is used to detect an object in a hover space. “Hover technology” and “hover-sensitive” refer to sensing an object spaced away from (e.g., not touching) yet in close proximity to a display in an electronic device “Close proximity” may mean, for example, beyond 1 mm but within 1 cm, beyond 0.1mm but within 10 cm, or other combinations of ranges. Being in close proximity includes being within a range where a proximity detector (e.g., capacitive sensor) can detect and characterize an object in the hover space. The device may be, for example, a phone, a tablet computer, a computer, or other device/accessory. Hover technology may depend on a proximity detector(s) associated with the device that is hover-sensitive. Example apparatus may include the proximity detector(s).

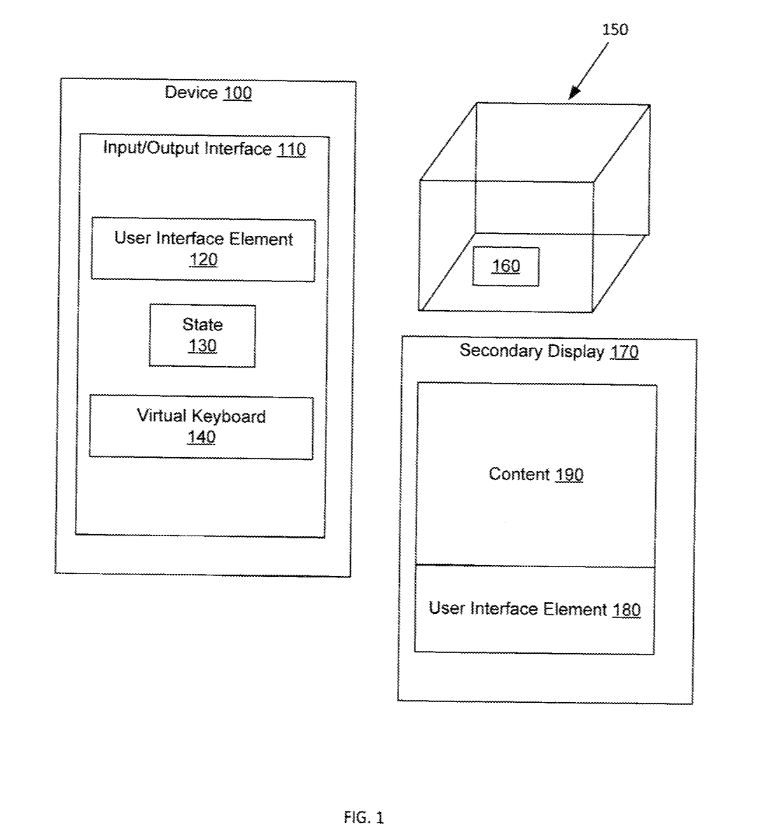

FIG. 1 illustrates an example device 100 that is both touch-sensitive and hover-sensitive. Device 100 includes an input/output (i/o) interface 110. I/O interface 110 is both touch-sensitive and hover-sensitive. I/O interface 110 may display a set of items including, for example, a virtual keyboard 140 and, more generically, a user interface element 120. User interface elements may be used to display information and to receive user interactions. Conventionally, user interactions were performed either by touching the i/o interface 110 or by hovering in the hover space 150. Example apparatus facilitate identifying and responding to input actions that use touch actions or hover actions or both to provide content 190 or user interface elements 180 to a secondary display 170 located off device 100. A hover action may be used to position or move a cursor on the secondary display 170 and a touch action may be used to activate the user interface element 180 located in the zone of influence of the cursor on the secondary display 170.

Device 100 or i/o interface 110 may store state 130 about the user interface element 120, a virtual keyboard 140, content 190, user interface element 180, secondary display 170, or other items. The state 130 of the user interface element 120 or user interface element 180 may depend on the order in which touch and hover actions occur, the number of touch and hover actions, whether the touch and hover actions are static or dynamic, whether the combined hover and touch actions describe a gesture, or on other properties of the touch and hover actions. The state 130 may include, for example, the location of a touch action, the location of a hover action, a gesture associated with the touch action, a gesture associated with the hover action, or other information.

The device 100 may include a touch detector that detects when an object (e.g., digit, pencil stylus with capacitive tip) is touching the i/o interface 110. The touch detector may report on the location (x, y) of an object that touches the i/o interface 110, the location of a cursor on secondary display 170, a user interface element that was activated on secondary display 170, or other information. The touch detector may also report on a direction in which the object is moving, a velocity at which the object is moving, whether the object performed a tap, double tap, triple tap or other tap action, whether the object performed a recognizable gesture, or other information.

The device 100 may also include a proximity detector that detects when an object (e.g., digit, pencil, stylus with capacitive tip) is close to but not touching the i/o interface 110. The proximity detector may identify the location (x, y, z) of an object 160 in the three-dimensional hover space 150, where x and y are orthogonal to each other and in a plane parallel to the surface of the interface 110 and z is perpendicular to the surface of interface 110. The proximity detector may also identify other attributes of the object 160 including, for example, the speed with which the object 160 is moving in the hover space 150, the orientation (e.g., pitch, roll, yaw) of the object 160 with respect to the hover space 150, the direction in which the object 160 is moving with respect to the hover space 150 or device 100, a gesture being made by the object 160, or other attributes of the object 160. While a single object 160 is illustrated, the proximity detector may detect more than one object in the hover space 150.

In different examples, the touch detector may use active or passive systems. Similarly, in different examples, the proximity detector may use active or passive systems. In one embodiment, a single apparatus may perform both the touch detector and proximity detector functions. The combined detector may use sensing technologies including, but not limited to, capacitive, electric field, inductive, Hall effect, Reed effect, Eddy current, magneto resistive, optical shadow, optical visual light, optical infrared (IR), optical color recognition, ultrasonic, acoustic emission, radar, heat, sonar, conductive, and resistive technologies. Active systems may include, among other systems, infrared or ultrasonic systems. Passive systems may include, among other systems, capacitive or optical shadow systems. In one embodiment, when the combined detector uses capacitive technology, the detector may include a set of capacitive sensing nodes to detect a capacitance change in the hover space 150 or on the i/o interface 110. The capacitance change may be caused, for example, by a digit(s) (e.g., finger, thumb) or other object(s) (e.g., pen, capacitive stylus) that touch the capacitive sensing nodes or that come within the detection range of the capacitive sensing nodes.

In general, a proximity detector includes a set of proximity sensors that generate a set of sensing fields on the i/o interface 110 and in the hover space 150 associated with the i/o interface 110. The touch detector generates a signal when an object touches the i/o interface 110 and the proximity detector generates a signal when an object is detected in the hover space 150. In one embodiment, a single detector may be employed for both touch detection and proximity detection, and thus a single signal may report a combined touch and hover event.

In one embodiment, characterizing a touch includes receiving a signal from a touch detection system (e.g., touch detector) provided by the device. The touch detection system may be an active detection system (e.g., infrared, ultrasonic), a passive detection system (e.g., capacitive), or a combination of systems. Characterizing a hover may also include receiving a signal from a hover detection system (e.g., hover detector) provided by the device. The hover detection system may also be an active detection system (e.g., infrared, ultrasonic), a passive detection system (e.g., capacitive), or a combination of systems. Characterizing a combined touch and hover event may also include receiving a signal from an active detection system or a passive detection system incorporated into the device. The signal may be, for example, a voltage, a current, an interrupt, a computer signal, an electronic signal, or other tangible signal through which a detector can provide information about an event the detector detected. In one embodiment, the touch detection system and the hover detection system may be the same system. In one embodiment, the touch detection system and the hover detection system may be incorporated into the device or provided by the device.

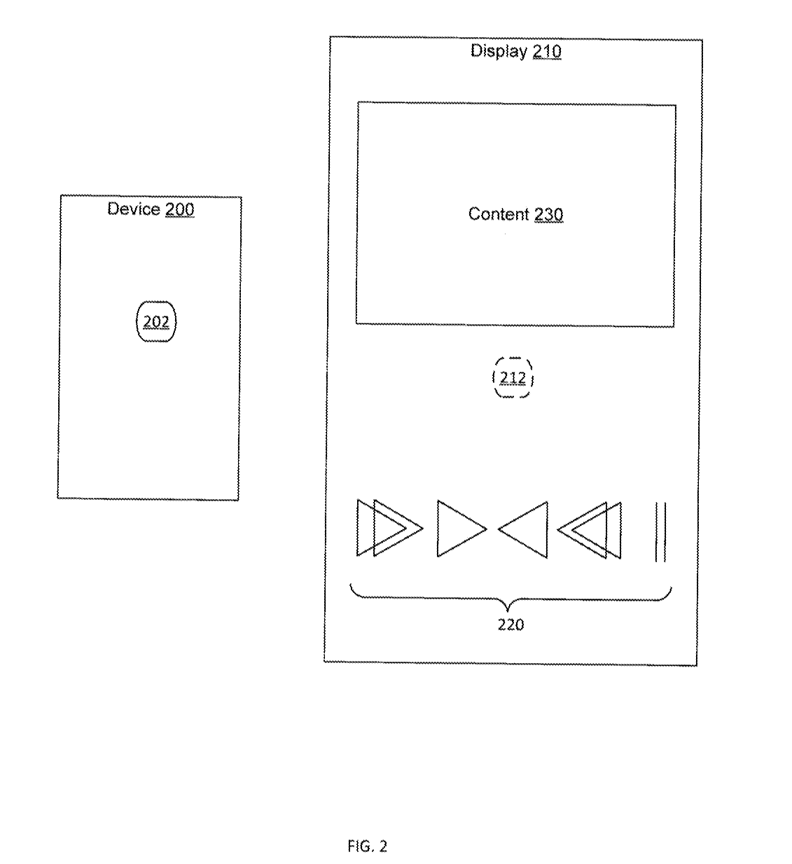

FIG. 2 illustrates a hover-sensitive device 200 (e.g., phone, tablet) interacting with a secondary display 210 (e.g.. television). Hover-sensitive device 200 may establish a communication link with the secondary display 210. Once communications have been established, then a hover action that produces a hover point 202 on device 200 may also produce actions on secondary display 210. For example, a set of controls 220 may be displayed on the secondary display 210 and a dotted circle 212 may be displayed on the secondary display 210 as a cursor or as a representation of the location of the user's digit. Which controls 220 are displayed may depend on the application that is providing content 230 (e.g., movie, document, game) to display 210. The size, shape, appearance, or other attributes of the cursor 212 may also depend on the application. A user may then move the hover point 202 to reposition the cursor 212. If the user positions the cursor 212 over a member of the controls 220 and then touches the hover-sensitive device 200, it may appear that the member of the controls 220 was pressed and a corresponding action associated with the member of the controls 220 may be generated. For example, pressing a pause button may pause the presentation of the content 230. The action may control the application that is providing the content to the display 210.

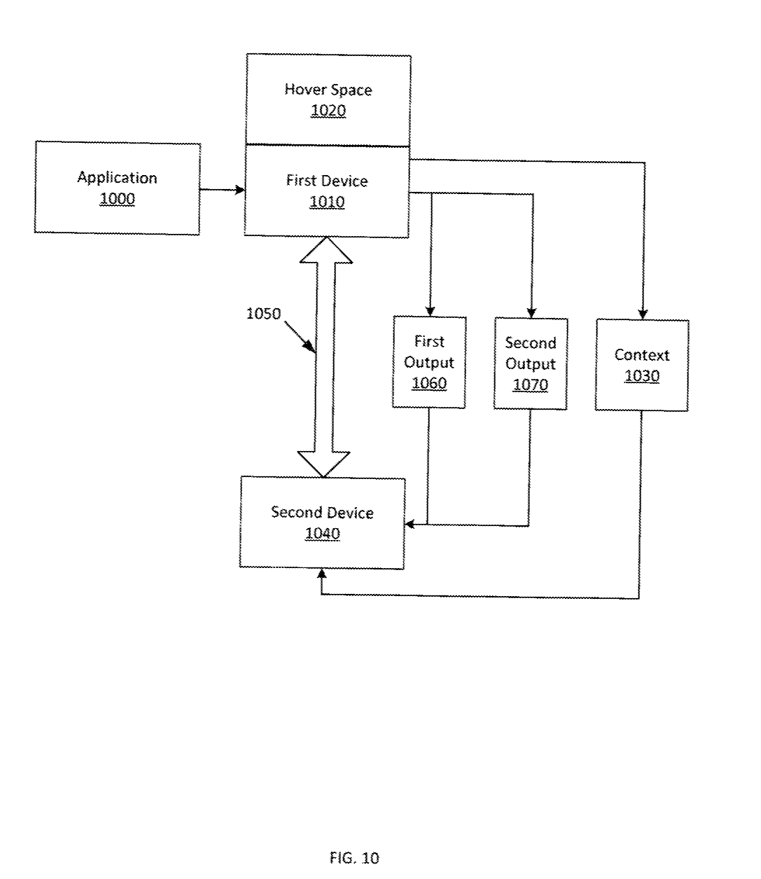

FIG. 10 illustrates a first device 1010 that is running an application 1000 The first device 1010 has a hover space 1020 in which hover actions can be detected. The first device 1010 may detect a second device 1040 that has a secondary display. The first device 1010 may negotiate or establish a context 1030 with the second device 1040. For example, the first device 1010 and the second device 1040 may decide for which applications the first device 1010 will provide content to the second device 1040 for display. The devices may also decide which controls, if any, are to be displayed on second device 1040 when a hover action occurs in hover space 1020. The devices may also decide which control events, if any, are to be generated when a cursor that is controlled by hover events in hover space 1020 but displayed on second device 1040 interacts with a control displayed on second device 1040 The content from application 1000 may be provided as a first output stream 1060 to the second device 1040. The cursor, controls, or other items that are not content generated by application 1000 may also be provided as a second output stream 1070 to the second device 1040. The first output stream 1060 and second output stream 1070 may be provided through a communication channel 1050 The communication channel 1050 may be wired or wireless.

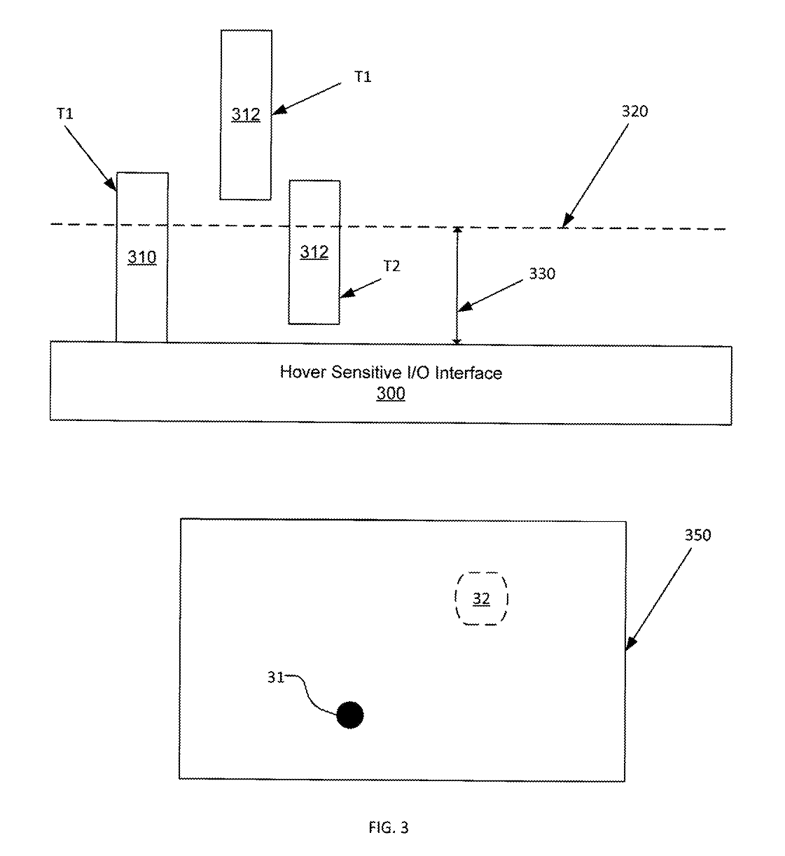

FIG. 3 illustrates a touch-sensitive and hover-sensitive i/o interface 300. Line 320 represents the outer limit of the hover space associated with hover-sensitive i/o interface 300. Line 320 is positioned at a distance 330 from i/o interface 300. Distance 330 and thus line 320 may have different dimensions and positions for different apparatus depending, for example, on the proximity detection technology used by a device that supports i/o interface 300.

Example apparatus and methods may identify objects located in the hover space bounded by i/o interface 300 and line 320. Example apparatus and methods may also identify objects that are touching the i/o interface 300. For example, device 300 may detect object 310 when it touches i/o interface 300 at time T1. A small solid dot 31 may be displayed on a secondary display 350 to provide visual feedback that object 310 is in contact with i/o interface 300. Since object 312 is neither touching i/o interface 310 nor in the hover zone for i/o interface 300, object 312 may not be detected at time T1. But at time T2, object 312 may enter the hover space and be detected. A large dotted circle 32 may be displayed on secondary display 350 to provide visual feedback that object 312 is in the hover space and that a hover point has been established for object 312.

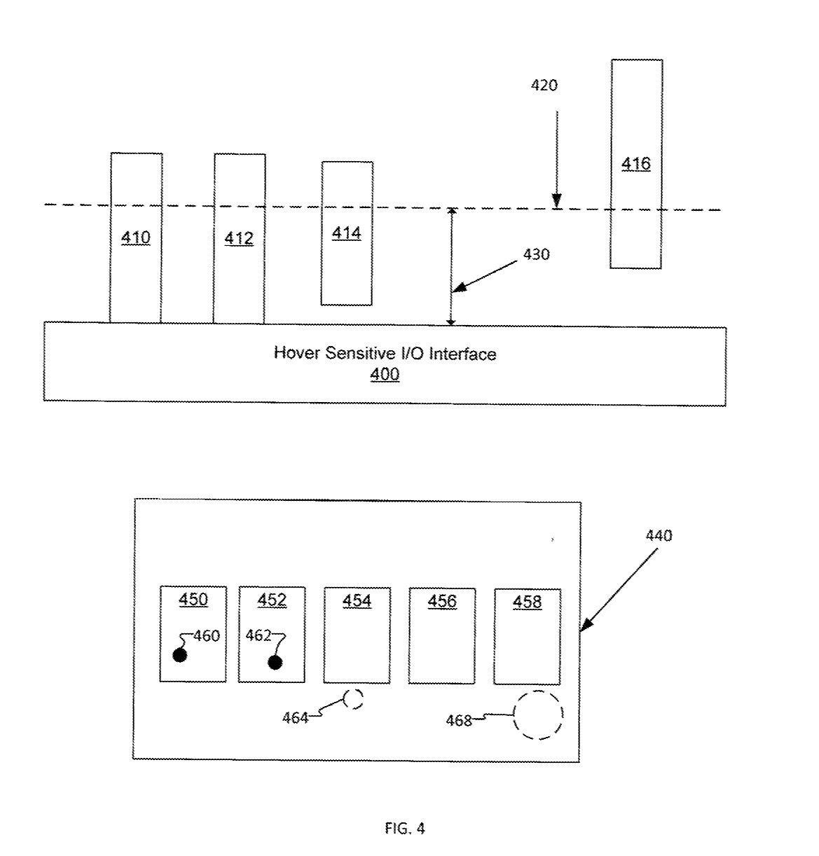

FIG. 4 illustrates a touch and hover-sensitive i/o interface 400. Line 420 depicts the limits of a hover space associated with i/o interface 400. Line 420 is positioned at a distance 430 from the i/o interface 400. The hover space may be present between the i/o interface 400 and line 420. While a straight line is illustrated, the hover space may vary in size and shape.

FIG. 4 illustrates object 410 touching the i/o interface 400 and object 412 touching the i/o interface 400. Additionally, FIG. 4 illustrates object 414 hovering in the hover space and object 416 hovering in the hover space. Object 416 may be located farther away from i/o interface 400 than object 414. In one embodiment, object 416 may simply hover over the i/o interface 400 with no user interface elements displayed on i/o interface 400. While some touch and hover actions may involve first touching the i/o interface 400 and then performing a hover action (e.g., typing), some touch and hover actions may involve first hovering over i/o interface 400 and then performing a touch. Since i/o interface 400 can detect multiple touch events and multiple hover events, and the order in which the events occur, and the combinations of events, a rich set of user interface interactions are possible. Objects 410, 412, 414 and 416 may cause hover cursors to be displayed on a secondary display 440. For example, a device associated with i/o interface 400 may be running an application that occasionally wants to accept multiple choice inputs. Thus, when an object enters the hover space, virtual multiple choice buttons 450, 452, 454, 466, and 458 may be presented on secondary display 440. Cursors or other indicators of the positions of objects 410, 412, 414, and 416 may also be displayed on secondary display 440. Small solid blinking dots 460 and 462 may indicate that objects 410 and 412 are touching i/o interface 400, Larger dotted circles 464 and 466 may indicate that objects 414 and 416 are hovering above i/o interface 400. As objects 414 and 416 move around in the hover space, dotted circles 464 and 466 may also move around and change size, shape, color, or other display attributes.

Some portions of the detailed descriptions that follow are presented in terms of algorithms and symbolic representations of operations an data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

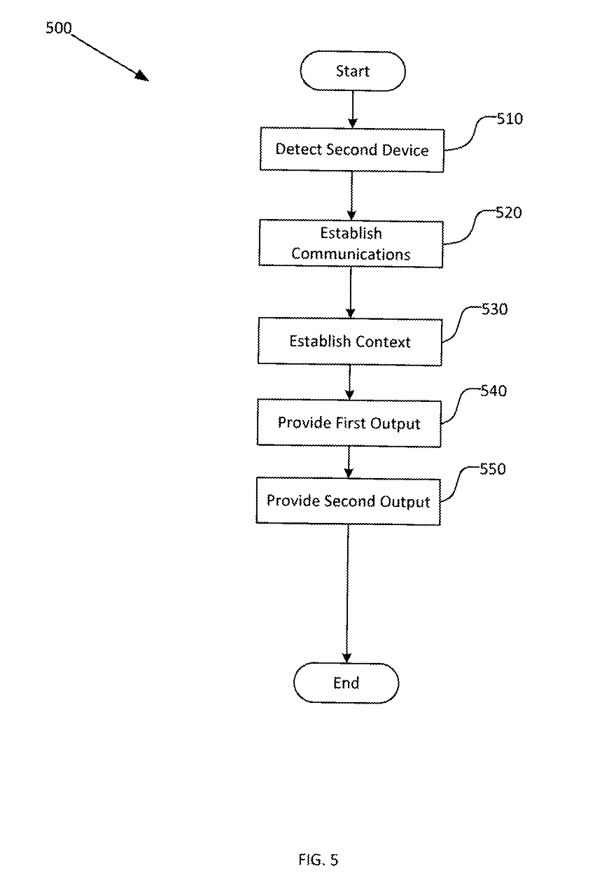

FIG. 5 illustrates an example method 500 associated with performing hover-sensitive control of a secondary display. Method 500 may be used to control a first device (e.g.. phone, tablet, computer) having a hover-sensitive and touch-sensitive interface. Method 500 may control the first device to provide content, cursors, controls, or other information to a display on a second device. Thus, method 500 includes, at, 510, detecting a second device having a second display. The second device may be, for example, a television, a monitor, a computer, or other device.

Method 500 includes, at 520, controlling the first device to establish a communication link between the first device and the second device. Establishing the communication link may include, for example, establishing a wired link or a wireless link. The wired link may be established using, for example, an HDMI (high definition multimedia interface) interface, a USB (universal serial bus) interface, or other interface. The wireless link may be established using, for example, a Miracast interface, a Bluetooth interface, an NFC (near field communication) interface, or other interface. A Miracast interface facilitates establishing a peer-to-peer wireless screencasting connection using WiFi direct connections. A Bluetooth interface facilitates exchanging data over short distances using short-wavelength microwave transmission in the ISM (Industrial, Scientific, Medical) band.

Method 500 also includes, at 530, controlling the first device to establish a context for an interaction between the first device and the second device. In one embodiment, establishing the context at 530 includes identifying the application that will produce content to be displayed on the second display. The application may be, for example, a movie presentation application, a television presentation application, a video game, a productivity application, a slide show application, or other application that produces content that can be viewed. Establishing the context at 530 may also include identifying a user interface element that may be displayed on the second display by the first device. Certain user interface elements make sense for certain applications. For example. DVD or VCR like controls make sense for a movie or television presentation application, but may not make sense for a video game. User interface elements that facilitate moving a character around a virtual world may be more appropriate for a video game. Thus, a set of user interface elements that may be displayed may be selected as part of establishing the context. Establishing the context at 530 may also include identifying a cursor that may be displayed on the second display by the first device, Different cursors may be appropriate for different applications. For example, a crosshairs may be appropriate for an application where targeting is involved but a pair of scissors or paint brush may be appropriate for an arts and crafts application.

Establishing the context at 530 may also include identifying whether a cursor location or movement will be independent of a location of the hover point. Unlike conventional applications that map locations on a touch-sensitive device directly to locations on a secondary display, and that map controls displayed on the first device to controls displayed on the secondary display, method 500 may decouple the one-to-one correspondence to allow the hover-sensitive device to produce motion that does not depend on a position over the hover-sensitive device but rather on a motion over the hover-sensitive device. Users are familiar with trackball like motion and with motion where, for example, a mouse is moved left to right, picked up and moved back to the left, placed down and moved left to right again, and so on. These types of motions have typically been difficult, if even possible to achieve with touch-sensitive devices being used in a conventional heads-down approach where touch-sensitive screen locations were mapped directly to secondary display locations. These types of motion are, however, possible with hover interactions.

Establishing the context at 530 may also include identifying a control event that can be generated in response to a touch event performed on the first device. Once again, different control events are appropriate for different applications. For a movie application with DVD-like controls, a press control event may be useful. However, for a video game application, control events including press, tap, double tap, drag, and others may be useful. Similarly, in a drawing application, control events like drag and drop, stretch, pinch, and other events may be useful.

Method 500 also includes, at 540, controlling the first device to provide a first output to be displayed on the second display. The first output is associated with content from an application associated with the first device. For example, for a movie application, the first output is the movie (e.g., stream of scenes) while for a video game the first output is the game screen and for a word processing application the content is the document being word processed. In one embodiment, the application may be running on the first device. In another embodiment, the application may be running on a third device or in the cloud and the content may be streamed through the first device.

Method 500 also includes, at 550, in response to identifying a hover point produced in a hover space associated with the first device, controlling the first device to provide a second output to be displayed on the second display. The second output may include a user interface element configured to control an operation of the application. The second output may also include a cursor. In an embodiment where the hover-sensitive device is being used like a virtual laser pointer, the second output may be just a cursor. In another embodiment where the hover-sensitive device is being used to provide controls with which a user may interact, the second output may include controls and a cursor. For example, the second output may include DVD-like controls and a cursor that can be positioned over or near one of the DVD-like controls.

Characteristics of the second output may be based, at least in part, on the context and on a hover action associated with the hover point. For example, the size, shape, color, or other appearance of the second output may be based on which application is running and what type of hover action occurred. On a hover enter event, where a hover point is first established, a large, dim cursor may be established on the secondary display. On a hover move event that brings the hover point closer to the hover-sensitive device, a smaller, brighter cursor may be presented on the secondary display. Thus, method 500 may include controlling an appearance (e.g., size, shape, color) of a cursor based on the z-distance of the hover point (e.g., distance of object generating hover event from hover-sensitive interface). Recall that the first output is content from the application (e.g., movie, game screen, document being edited) and that the second output is not content from the application. The second output may facilitate working with or manipulating the application or the first output.

While method 500 has been described in connection with a single first device, method 500 may not be so limited. In one embodiment, hover actions may be detected on two or more hover-sensitive devices. Thus, method 500 may include, in response to identifying an additional hover point produced in an additional hover space associated with a third device, providing an additional output to be displayed on the second display. The additional output may be based, at least in part, on the context and on an additional hover action associated with the additional hover point. For example, two garners may be playing a football game. A first gamer may have a first cursor associated with their team in one color and a second gamer may have a second cursor associated with their team in another color. Both cursors may be displayed on a shared game display where the football game is being displayed.

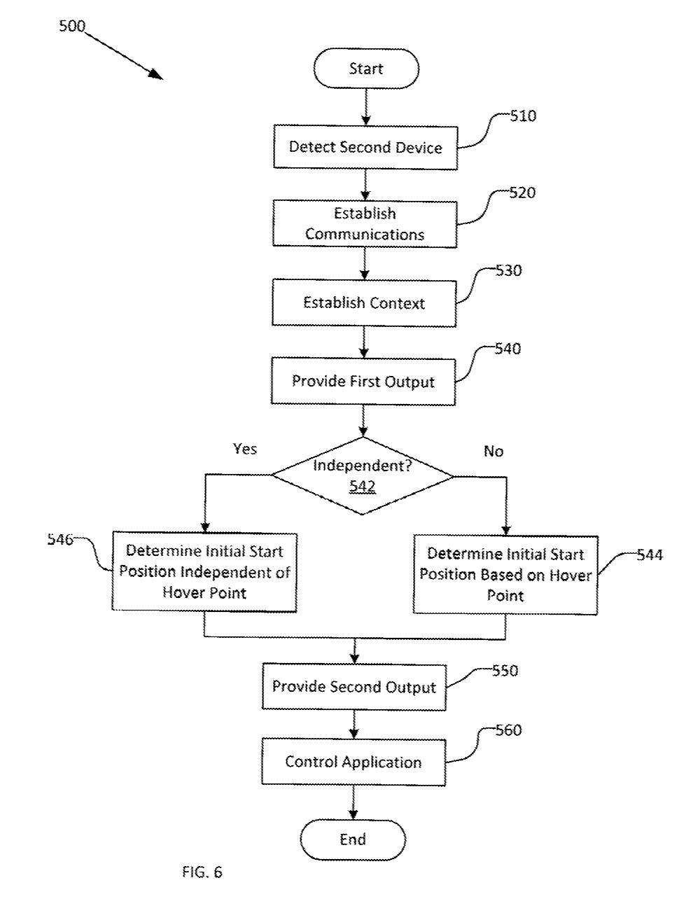

FIG. 6 illustrates another embodiment of method 500. This embodiment also includes additional actions. For example, this embodiment includes, at 542, determining whether the initial location of a cursor to be displayed on the secondary display will be independent of the position of the hover point. If the determination at 542 is yes, then method 500 proceeds, at 546, to determine the initial location independent of the position of the hover point. For example, the initial location may be in the center of the secondary display, on or near the most likely to be used control, equidistant between two controls, centered in a group of controls, or in another location that does not depend on the location of the hover point. When the location of the cursor does not depend on the position of the hover point, there is no reason to look down at the hover-sensitive device, which promotes heads-up operation. If the determination at 544 is no, then method 500 proceeds, at 544, to determine the initial position of the cursor based on the hover point.

Like the initial point may be independent of the location of the hover point, how the cursor is moved may also be tied to a location in the hover space or decoupled from a specific location in the hover space and instead determined by motion in the hover space. Thus, in different embodiments, method 500 may control a subsequent location of the cursor based on motion of the hover point or on the location of the hover point.

This embodiment of method 500 may also include, at 560, controlling the application as a function of the location of the cursor on the second display when a touch event on the first device is detected. For example, different actions may be taken if the touch event occurs when the cursor is over a first control (e.g., stop), over a second button (e.g., play), or not over a control at all. Note once again that the action may depend on visual cues and information on the second display and not on the location of the hover point in the first device,

While FIGS. 5 and 6 illustrate various actions occurring in serial, it is to be appreciated that various actions illustrated in FIGS. 5 and 6 could occur substantially in parallel. By way of illustration, a first process could control content to be displayed, a second process could control cursors and controls to be displayed, and a third process could generate or handle control events. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 500 or 600. While executable instructions associated with the listed methods are described as being stored on a computer-readable storage medium, it is to be appreciated that executable instructions associated with other example methods described or claimed herein may also be stored on a computer-readable storage medium. In different embodiments, the example methods described herein may be triggered in different ways. In one embodiment, a method may be triggered manually by a user. In another example, a method may be triggered automatically.

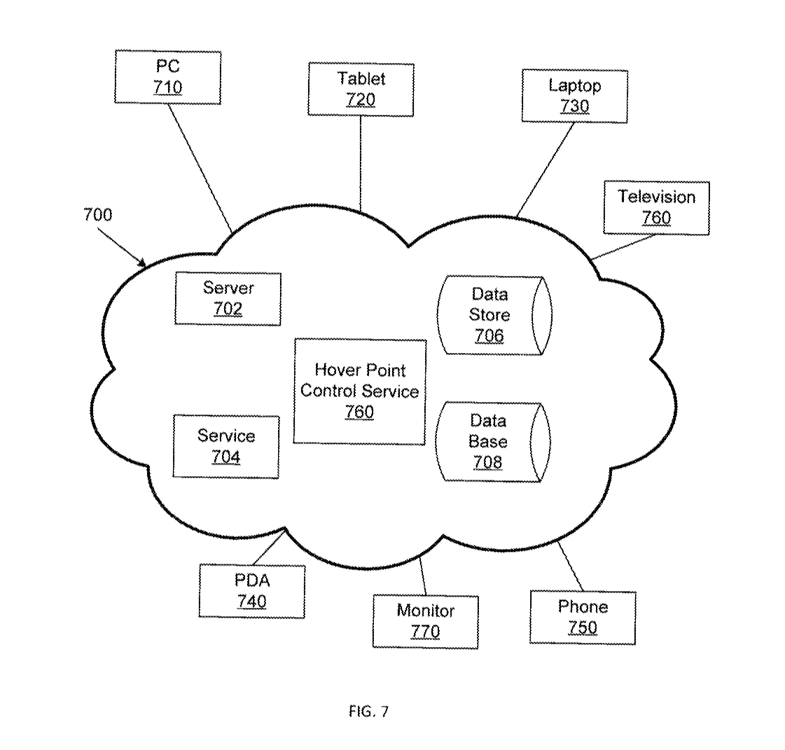

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service, in the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example hover point control service 760 residing in the cloud 700. The hover point control service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud 700 and may, therefore, be used by the hover point control service 760.

FIG. 7 illustrates various devices accessing the hover point control service 760 in the cloud 700. The devices include a computer 710, a tablet 720, a laptop computer 730, a desktop monitor 770, a television 760, a personal digital assistant 740, and a mobile device (e.g., cellular phone, satellite phone) 750. It is possible that different users at different locations using different devices may access the hover point control service 760 through different networks or interfaces. In one example, the hover point control service 760 may be accessed by a mobile device 750. In another example, portions of hover point control service 760 may reside on a mobile device 750. Hover point control service 760 may perform actions including, for example, presenting a hover cursor on a secondary display, presenting controls on a secondary display, generating a control event in response to an interaction between a hover cursor and a control on the secondary display, or other service. In one embodiment, hover point control service 760 may perform portions of methods described herein (e.g., method 500, method 600).

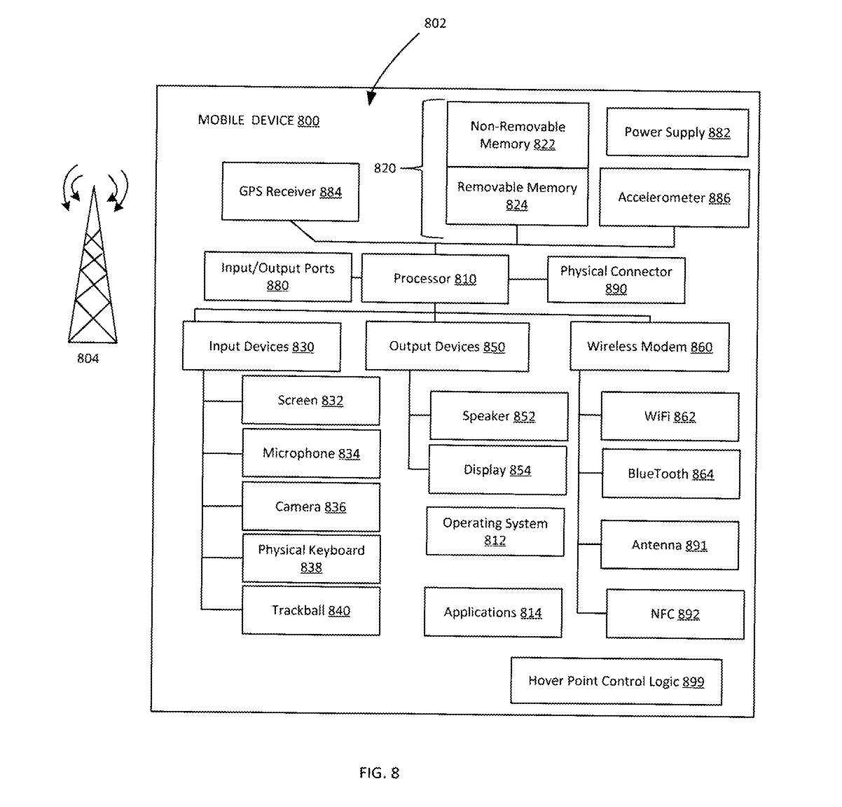

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer. Personal Digital Assistant (PDA), etc.) and may allow wireless two-way communications with one or more mobile com unications networks 804, such as a cellular or satellite networks.

Mobile device 800 can include a controller or processor 810 (e.g., signal processor, microprocessor, application specific integrated circuit (ASIC), or other control and processing logic circuitry) for performing tasks including touch detection, hover detection, hover point control on a secondary display, signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), video games, movie players, television players, productivity applications, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards,” The memory 820 can be used for storing data or code for running the operating system 812 and the applications 814. Example data can include touch action data, hover action data, combination touch and hover action data, user interface element state, cursor data, hover control data, hover action data, control event data, web pages, text, images, sound files, video data, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMO). The identifiers can be transmitted to a network server to identify users or equipment.

The mobile device 800 can support one or more input devices 830 including, but not limited to, a screen 832 that is both touch and hover-sensitive, a microphone 834, a camera 836, a physical keyboard 838, or trackball 840. The mobile device 800 may also support output devices 850 including, but not limited to, a speaker 852 and a display 854. Display 854 may be incorporated into a touch-sensitive and hover-sensitive i/o interface. Other possible input devices (not shown) include accelerometers (e.g., one dimensional, two dimensional, three dimensional). Other possible output devices (not shown) can include piezoelectric or other haptic output devices. Some devices can serve more than one input/output function. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (electro-encephalogram (EEG) and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting touch and hover gestures associated with controlling output actions on a secondary display.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices that have secondary displays whose content or control elements may be controlled, at least in part, by hover point control logic 899. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a hover point control logic 899 that is configured to provide a functionality for the mobile device 800 and for controlling content or controls displayed on a secondary display with which mobile device 800 is interacting. For example, hover point control logic 899 may provide a client for interacting with a service (e.g., service 760, FIG. 7) Portions of the example methods described herein may be performed by hover point control logic 899. Similarly, hover point control logic 899 may implement portions of apparatus described herein.

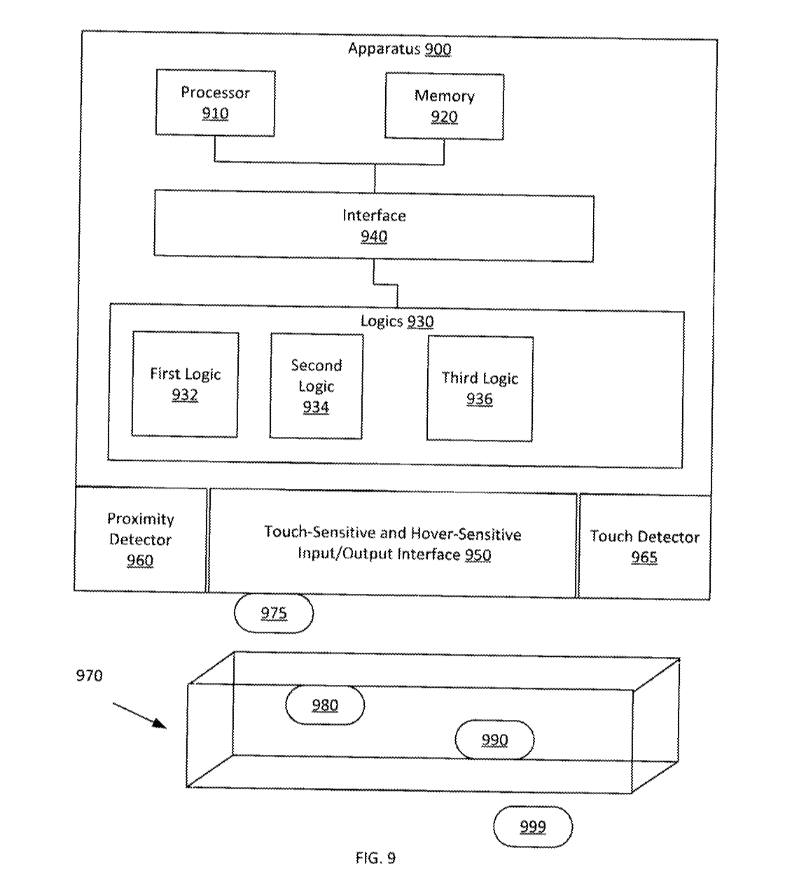

FIG. 9 illustrates an apparatus 900 that provides a hover point control interface. In one example, the apparatus 900 includes an interface 940 configured to connect a processor 910, a memory 920, a set of logics 930, a proximity detector 960, a touch detector 965, and a touch-sensitive and hover-sensitive i/o interface 950. The set of logics 930 may be configured to provide hover point control for a secondary display associated with a second, different apparatus. In one embodiment, the proximity detector 960 and the touch detector 965 may share a set of capacitive sensing nodes that provide both touch-sensitivity and hover-sensitivity for the input/output interface. Elements of the apparatus 900 may be configured to communicate with each other, but not all connections have been shown for clarity of illustration.

The touch detector 965 may detect when an object 975 touches the i/o interface 950. The proximity detector 960 may detect an object 980 in a hover space 970 associated with the apparatus 900. The hover space 970 may be, for example, a three dimensional volume disposed in proximity to the i/o interface 950 and in an area accessible to the proximity detector 960. The hover space 970 has finite bounds. Therefore the proximity detector 960 may not detect an object 999 that is positioned outside the hover space 970.

Apparatus 900 may include a first logic 932 that is configured to provide content to be displayed on the secondary display. The content may be produced, for example, by an application running, at least partially, on the apparatus 900. The application may be, for example, a movie presentation application, a television presentation application, a productivity application (e.g., word processor, spread sheet), a video game, or other application that has content to be viewed. The application may run partially or completely on the apparatus 900. The application may run partially on apparatus 900 when, for example, some processing is performed on another apparatus or in the cloud.

Apparatus 900 may include a second logic 934 that is configured to provide overlay material to be displayed on the secondary display. There is a distinction between what is provided by the first logic 932 and the second logic 934. The overlay material provided by the second logic 934 is not content that is produced by the application. Consider a video game. The “content” provided by the first logic 932 may be a game map, avatars, weapons, explosions, and other images associated with the game. The overlay material provided by the second logic 934 may be, for example, control buttons, navigation tools, a cursor for interacting with the control buttons, or other images that are not part of the game, even though they may be involved in game play. Consider a movie. The “content” provided by the first logic 932 is the scenes from the movie. The overlay material provided by the second logic 934 may be virtual DVD controls (e.g., play, pause, rewind, fast forward) for selecting which scenes to view.

In one embodiment, the overlay material may include a position indicator (e.g., cursor). In this embodiment, the second logic 934 may be configured to provide the position indicator in response to detecting a hover point in a hover space 970 produced by the input/output interface 950. In one embodiment, the overlay material may also include a user interface element that is configured to control the application. In this embodiment, the second logic 934 may be configured to provide the user interface element in response to detecting the hover point in the hover space 970. The user interface element may be, for example, a button or other control that a user may activate by positioning the cursor and touching the input/output interface 950.

In one embodiment, the overlay material may be selected based, at least in part, on the application running on the apparatus 900. For example, the size, shape, color, or other appearance of the cursor may be determined by which application is running. Similarly, which controls are to be displayed and the control events that may be generated by interacting with the controls may be determined by which application is running. For example, when a movie is playing, the controls may include stop, forward, and reverse controls and the cursor may be a tub of popcorn. But when a first person shooter is being played, the controls may include shoot and reload and the cursor may be a bulls-eye symbol. Other cursors and other controls may be employed.

The second logic 934 may make a decision concerning where to initially position the cursor when a hover point is established. Rather than place the cursor at a position corresponding to the hover point as is done by conventional touch based systems, the second logic 934 may seek to optimize the user experience by, for example, minimizing the distance a user may have to move the cursor to achieve an effect. Thus, the initial location may be independent of a location of the hover point with respect to the input/output interface 950. Therefore, in one embodiment, the second logic 934 may be configured to determine an initial location for the position indicator based, for example, on the location of the user interface element. The initial location may be, for example, in the center of a secondary display, over or near a control that is most likely to be used, equidistant between two controls, or in other locations determined by the context rather than by the location of the hover point in the hover space 970.

Apparatus 900 may include a third logic 936 that is configured to selectively control the application. The control may be based, at least in part, on an action associated with the overlay material. For example, moving the cursor to one side or the other of the secondary display by making hover actions in the hover space 970 may cause the content to scroll in a direction determined by the position of the cursor. In another example, moving the cursor over or near a user control element provided by apparatus 900 and displayed on the secondary display may cause an action to occur. In one embodiment, the third logic 936 may be configured to produce a control action upon detecting a touch on the input/output interface 950. In this embodiment, a user may cause a cursor and controls to be displayed on the secondary display in response to a hover action in the hover space 970, may position the cursor using hover actions in the hover space 970, and may then cause the control event by touching the input/output interface 950. In one embodiment, the hover actions in the hover space 970 may resemble interactions with a virtual hovering track ball.

In one embodiment, the control action produced by the third logic 936 may depend, at least in part, on the location of the position indicator and the location of the user interface element. For example, the relationship between a cursor and a game control button displayed on the secondary display may determine the action rather than the location of a user's digit in the hover space 970. Thus, the control action may be independent of the location of the hover point.

Apparatus 900 may include a memory 920. Memory 920 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 920 may be configured to store user interface state information, characterization data, object data, or other data.

Apparatus 900 may include a processor 910. Processor 910 may be, for example, a signal processor, a microprocessor, an application specific integrated circuit (ASIC), or other control and processing logic circuitry for performing tasks including signal coding, data processing, input/output processing, power control, or other functions. Processor 910 may be configured to interact with logics 930 that provide hover point control processing.

In one embodiment, the apparatus 900 may be a general purpose computer that has been transformed into a special purpose computer through the inclusion of the set of logics 930. The set of logics 930 may be configured to provide hover point control. Apparatus 900 may interact with other apparatus, processes, and services through, for example, a computer network.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic, Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g.. A or B) it is intended to mean “A or B or both”. When the Applicant intends to indicate “only A or B but not both” then the term only A or B but not both* will be employed. Thus, use of the term “or” herein is the inclusive, and not the exclusive use. See, Bryan A. Garner. A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is

1. A method for controlling a first device having a hover-sensitive and touch-sensitive display, comprising:
detecting a second device having a second display;
controlling the first device to establish a communication fink between the first device and the second device;
controlling the first device to establish a context for an interaction between the first device and the second device;
controlling the first device to provide a first output to be displayed on the second display, where the first output is associated with content from an application associated with the first device; and
in response to identifying a hover point produced in a hover space associated with the first device, controlling the first device to provide a second output to be displayed on the second display, where the second output is based, at least in part, on the context and on a hover action associated with the hover point, and where the second output is not content from the application.

2. The method of claim 1, where the second output is a user interface element configured to control an operation of the application.

3. The method of claim 1, where the second output is a cursor.

4. The method of claim 3, comprising controlling an appearance of the cursor based on the context or z-distance of the hover point.

5. The method of claim 3, comprising controlling an initial location of the cursor based on the position of the hover point.

6. The method of claim 3, comprising controlling an initial location of the cursor independent of the position of the hover point.

7. The method of claim 6, comprising controlling a subsequent location of the cursor based on motion of the hover point.

8. The method of claim 1, comprising, upon detecting a touch event on the first device, controlling the application as a function of the location of the cursor on the second display.

9. The method of claim 1, where establishing the communication link includes establishing a wired link or a wireless link.

10. The method of claim 1, where the application is running on the first device or where the application is running on a third device.

11. The method of claim 1, comprising:
in response to identifying an additional hover point produced in an additional hover space associated with a third device, the third device having a hover-sensitive and touch-sensitive interface, providing an additional output to be displayed on the second display, where the additional output is based, at least in part, on the context and on an additional hover action associated with the additional hover point.

12. The method of claim 1, where establishing the context includes:
identifying the application that will produce content to be displayed on the second display;
identifying a user interface element that may be displayed on the second display by the first device;
identifying a cursor that may be displayed on the second display by the first device;
identifying whether a cursor location or movement will be independent of a location of the hover point; and
identifying a control event that can be generated in response to a touch event performed on the first device.

13. A computer-readable storage medium storing computer-executable instructions that when executed by a computer cause the computer to perform a method for controlling a first device having a hover-sensitive and touch-sensitive display, the method comprising:
detecting a second device having a second display;
controlling the first device to establish a communication link between the first device and the second device, where the communication link is a wired link or a wireless link;
controlling the first device to establish a context for an interaction between the first device and the second device, where establishing the context includes:
identifying an application that will produce content to be displayed on the second display;
identifying a user interface element that may be displayed on the second display by the first device;
identifying a cursor that may be displayed on the second display by the first device;
identifying whether a cursor location or movement will be independent of a location of a hover point; and
identifying a control event that can be generated in response to a touch event performed on the first device;
controlling the first device to provide a first output to be displayed on the second display, where the first output is associated with content from the application, where the application is running on the first device or where the application is running on a third device;
in response to identifying the hover point produced in a hover space associated with the first device, controlling the first device to provide a second output to be displayed on the second display, where the second output is a user interface element configured to control an operation of the application or is a cursor, where the second output is based, at least in part, on the context and on a hover action associated with the hover point, and where the second output is not content from the application;
controlling an appearance of the cursor based on the z-distance of the hover point;
controlling an initial location of the cursor independent of the position of the hover point and controlling a subsequent location of the cursor based on motion of the hover point; and
upon detecting a touch event on the first device, controlling the application as a function of the location of the cursor on the second display,

14. An apparatus, comprising:
a processor;
a memory;
an input/output interface that is both touch-sensitive and hover-sensitive;
a set of logics configured to provide hover point control for a secondary display associated with a second, different apparatus, and an interface to connect the processor, the memory, and the set of logics, the set of logics comprising:
a first logic configured to provide content to be displayed on the secondary display, where the content is produced by an application running, at least partially, on the apparatus;
a second logic configured to provide overlay material to be displayed on the secondary display, where the overlay material is content not produced by the application; and
a third logic configured to selectively control the application based, at least in part, on an action associated with the overlay material.

15. The apparatus of claim 14, where the overlay material is a position indicator, and where the second logic is configured to provide the position indicator in response to detecting a hover point in a hover space produced by the input/output interface,

16. The apparatus of claim 15, where the overlay material is a user interface element configured to control the application, and where the second logic is configured to provide the user interface element in response to detecting the hover point in the hover space.

17. The apparatus of claim 16, where the overlay material is selected based, at least in part, on the application running on the apparatus.

18. The apparatus of claim 17, where the second logic is configured to determine an initial location for the position indicator, where the initial location is based, at least in part, on the location of the user interface element, and where the initial location is independent of a location of the hover point with respect to the input/output interface.

19. The apparatus of claim 18, where the third logic is configured to produce a control action upon detecting a touch on the input/output interface.

20. The apparatus of claim 19, where the control action produced by the third logic depends, at least in part, on the location of the position indicator and the location of the user interface element, and where the control action is independent of the location of the hover point.
